(19) United States
(12) Patent Application Publication
(10) Pub. No.: US 2013/0335883 A1
(43) Pub. Date: Dec. 19, 2013

(54) POROUS CARBON MATERIAL AND METHOD OF PRODUCING THE SAME, AND ELECTRIC DOUBLE-LAYER CAPACITOR USING THE POROUS CARBON MATERIAL

(71) Applicant: TOYO TANSO CO., LTD., Osaka-shi (JP)

(72) Inventors: Yasushi SONEDA, Tsukuba-shi (JP); Masaya KODAMA, Tsukuba-shi (JP); Takahiro MORISHITA, Osaka-shi (JP)

(73) Assignee: TOYO TANSO CO., LTD., Osaka-shi (JP)

(21) Appl. No.: 13/852,494

(22) Filed: Mar. 28, 2013

(30) Foreign Application Priority Data
Jun. 15, 2012 (JP) 2012-136422

(51) Int. Cl. H01G 11/38; H01G 11/32

(52) U.S. Cl. CPC H01G 11/38; H01G 11/32
USPC 361/502; 423/445 R; 252/511

(57) ABSTRACT

A porous carbon material, in which a total pore volume is 1 mL/g or more, and in which a ratio of a mesopore volume to the total pore volume is 50% or more; a method of producing the same; and an electric double-layer capacitor containing the same.

### TECHNICAL FIELD

The present invention relates to a porous carbon material and a method of producing the same, and to an electric double-layer capacitor using the porous carbon material in an electrode, which capacitor can be operated under a quite low temperature.

### BACKGROUND ART

Electric double-layer capacitors (EDLCs) are large in electrostatic capacity, and excellent in charge/discharge cycle characteristics, and thus they are used as backup power sources in various equipments, including automobiles. To the EDLCs, use may be made of a polarizable electrode obtained by forming an active carbon with a binder resin, such as polytetrafluoroethylene, into a sheet form. As an electrolyte, use may be made of a propylene carbonate solution, in which a quaternary ammonium salt, such as a tetraethyl ammonium salt, is dissolved. In this case, as an anion, a boron tetrafluoride has been most frequently used. However, the electrolyte becomes an obstacle against the operation of the EDLC, when the viscosity of the electrolyte becomes larger under a low temperature. In other words, it is difficult for the EDLC to exhibit a required performance when its capacity is lowered under a low temperature.

As a method of producing the active carbon used in the polarizable electrode, a method is proposed which method includes: providing magnesium salt of an organic acid or the like, as a raw material, calcinating the magnesium salt, to prepare a composite of carbon and magnesium oxide (MgO), and removing the MgO by elusion by treating the composite with an acid, thereby preparing a porous carbon (see Patent Literature 1). In this Patent Literature 1, even when this material is used in a capacitor electrode, no knowledge on the operation under a quite low temperature has been acquired.

Some conventional techniques are found, which pertain to the attempts to improve the behavior of EDLCs under a low temperature. Most of those relate to the effects of additives to an electrolyte and to the studies of the electrolyte or an alternative material to the electrolyte, and there are not so many studies on a carbon material itself (for example, see Patent Literatures 2 to 10). Further, in each of those, a low-temperature test was conducted from −25° C. to −30° C., and the lowest test temperature of those corresponds to the lower limit temperature in the practical use. Thus, no EDLC that operates under a temperature lower than −30° C. has been known hitherto.

The use of the EDLCs has been rapidly spread, and in the case, for example, of mounting the EDLCs on automobiles or the like in cold climates in the winter season, and installing the EDLCs in intermountain regions in combination with power generation by wind, it is an urgent task to ensure the operation of the EDLCs under a quite low temperature lower than −30° C.

### CITATION LIST

### Patent Literature

Patent Literature 1: JP-A-2008-013394 (“JP-A” means unexamined published Japanese patent application)

Patent Literature 2: JP-A-2008-184359

Patent Literature 3: JP-A-2008-181950

Patent Literature 4: JP-A-2008-181949

Patent Literature 5: JP-A-2008-169071

Patent Literature 6: JP-A-2008-141060

Patent Literature 7: JP-A-2007-186411

Patent Literature 8: JP-A-2007-088410

Patent Literature 9: JP-A-2005-259760

Patent Literature 10: JP-A-11-297577 (JP-A-1999-297577)

### SUMMARY OF INVENTION

### Technical Problem

The present invention is contemplated for providing a porous carbon material, which has an excellent property as an electrode material for an electric double-layer capacitor, particularly which makes it possible to operate the electric double-layer capacitor under a quite low temperature lower than −30° C., and for providing a method of producing the same and an electric double-layer capacitor using the same.

### Solution to Problem

According to the present invention, there is provided the following means:
(1) A porous carbon material, wherein a total pore volume is 1 mL/g or more, and wherein a ratio of a mesopore volume to the total pore volume is 50% or more.
(2) The porous carbon material according to (1), which is obtainable by: heating magnesium citrate to 500° C. or more under an inert atmosphere, followed by cooling and then washing with an acid.
(3) An electrode material for an electric double-layer capacitor, which is obtained by: binding the porous carbon material according to (1) or (2) with a binder resin.
(4) An electric double-layer capacitor, comprising the electrode material for an electric double-layer capacitor according to (3) in an electrode.
(5) The electric double-layer capacitor according to (4), wherein an electric power holding ratio at −40° C. or lower to an electric power at 20° C. is 90% or higher.
(6) The electric double-layer capacitor according to (4) or (5), wherein an electric power holding ratio at −60° C. or lower to an electric power at 20° C. is 70% or higher.
(7) A method of producing a porous carbon material, comprising the steps of:
   heating magnesium citrate under an inert atmosphere to 500° C. or higher;
   cooling; and
   washing with an acid,
   wherein the porous carbon material has a total pore volume of 1 mL/g or more, and a ratio of a mesopore volume to the total pore volume of 50% or higher.
(8) The method of producing a porous carbon material according to (7), wherein, in the heating step, a temperature rising speed to a retention temperature at 500° C. or higher is 1 to 100° C./min.
(9) The method of producing a porous carbon material according to (7) or (8), wherein, in the heating step, a retention time period at 500° C. or higher after being raised to 500° C. is 1 to 5,000 minutes.
(10) The method of producing a porous carbon material according to any one of (7) to (9), which comprises: removing a surface oxygen-containing functional group, after the steps of cooling and washing with an acid.

Herein, in the present invention, the total pore volume means the value, which is measured as a saturated adsorption amount at a relative pressure of 0.95 [-], based on a nitrogen or argon gas adsorption isotherm. Further, the mesopore volume means the value of a volume, which is obtained by: subtracting a micropore volume, which is calculated by a Dubinin-Radushkevich method or a Horvath-Kawazoe method, based on the above gas adsorption isotherm, from the total pore volume.

### Advantageous Effects of Invention

According to the present invention, it becomes possible to produce a porous carbon material, which is large in the total pore volume and large in a ratio of mesopores (i.e. pores with diameters of 2 to 50 nm), which was difficult to be obtained with the conventional technique, by using, as a template, MgO formed via heating of magnesium citrate. This porous carbon material has micropores (i.e. pores with diameters of lower than 2 nm) that contribute to the formation of an electric double-layer, and mesopores that make arrival of electrolyte ions at the micropores readily, in a large amount. Further, due to having a large amount of mesopores, even when the viscosity of the electrolyte is largely increased under a quite low temperature, lowering of a capacity of a capacitor is not observed, which occurs in other active carbons, thus, the porous carbon material exhibits an excellent property. Based on those, the electric double-layer capacitor using the porous carbon material of the present invention has a high capacity of a capacitor under a quite low temperature, and such a high capacity of a capacitor is not observed in other carbon materials.

### MODE FOR CARRYING OUT THE INVENTION

### <<Porous Carbon Material>>

The porous carbon material of the present invention has the total pore volume of 1 mL/g or higher, and has the ratio of the mesopore volume to the total pore volume (i.e. a mesopore volume ratio) of 50% or higher.

The porous carbon material of the present invention can be produced, by heating magnesium citrate under an inert atmosphere, followed by cooling and washing with an acid. Upon this heating, the magnesium (Mg) in the magnesium citrate is oxidized to form fine magnesium oxide (MgO), and a carbon film derived from the citrate component in the raw material is formed at the circumference of a particle of the MgO. By removing the MgO from the resultant product by washing the MgO with a solution of a MgO-soluble acid, such as sulfuric acid and hydrochloric acid, a carbon film having mesopores on the inside thereof, with the diameters of the mesopores corresponding to the diameters of MgO particles, remains, which becomes the porous carbon material.

There is no limitation on the magnesium citrate, which may be an anhydride {trimagnesium dicitrate anhydride Mg₃(C₆H₅O₇)₂} or a hydrate {for example, typically, trimagnesium dicitrate nonahydrate Mg₃(C₆H₅O₇)₂.9H₂O}.

### <Step of Heating Magnesium Citrate>

This step is a step of obtaining a composite material with magnesium oxide particles dispersed in a carbon matrix, via heating magnesium citrate.

The heating temperature for heating magnesium citrate is preferably 500° C. or more, more preferably from 800° C. to 1,000° C. By heating to such a temperature, the thermal decomposition of the raw material proceeds, MgO to be the origin of a corresponding mesopore is formed, to proceed the formation of micropores in a carbon skeleton. Further, an electrical resistance suitable for an electrode for an electric double-layer capacitor can be obtained, which is also advantageous for the homogenization of the pores in the carbon skeleton.

The temperature rising speed to the above-mentioned temperature is preferably from 1 to 100° C./min, more preferably from 5 to 20° C./min. By controlling the temperature rising speed to such a range, thermal decomposition proceeds stably and crystallization proceeds more favorably.

The above-mentioned temperature after being raised by heating is kept or retained for a time period of preferably from 1 to 5,000 min, more preferably from 30 to 300 min, and further preferably from 60 to 300 min. By this retention time period, elimination of light elements in the carbon matrix proceeds, which makes it possible to control the specific surface area and pore volume of the thus-obtained porous carbon material.

The reaction atmosphere at that reaction is conducted under an inert atmosphere, such as under a nitrogen atmosphere.

### <Step of Cooling>

This step is a step of cooling the thus-calcined sample obtained above, in order to wash it with an acid. In this step, the calcined sample is cooled to room temperature (for example, from 20 to 25° C.). The cooling method is not particularly limited, and natural cooling may be employed.

### <Step of Washing With Acid>

This step is a step of dissolving the MgO particles to remove from the composite material in which the MgO particles are dispersed in the carbon matrix obtained from the heating step, thereby to obtain a porous carbon material.

The MgO particles can be removed, according to a method of dissolving the MgO particles, preferably, the MgO particles can be removed by treating with an acid, for example, sulfuric acid or hydrochloric acid. By immersing the composite material, in which the MgO particles are dispersed in the carbon matrix, in sulfuric acid or hydrochloric acid, to wash the same with the acid, MgO is dissolved in this acid. Generally, by carrying out the washing for 3 hours or more, MgO can be removed sufficiently.

### <Steps of Water Washing and Drying>

These steps are to wash the sample treated in the acid washing step, with pure water, to completely remove the acid therefrom, followed by drying.

### <Treatment For Highly Purification>

It is preferable that the resultant porous carbon material obtained by drying, is further subjected to a highly purification treatment, by heating under an inert atmosphere, to remove a surface oxygen-containing functional group therefrom. Examples of the surface oxygen-containing functional group include a carbonyl group, a phenolic hydroxyl group, a lactone group, and a carboxyl group, each of which is present on the surface of the porous carbon material.

A heating temperature in this step is preferably 500° C. or higher, more preferably from 800 to 1,200° C., and further preferably from 900 to 1,100° C. Further, a temperature rising speed in this step is preferably 5° C./min, and a heating time period is preferably from 1 to 2 hours.

The total pore volume of the porous carbon material of the present invention is preferably 1.5 mL/g or more, more preferably 2.0 mL/g or more. The upper limit of the total pore volume is not particularly limited, and is 3.0 mL/g or less practically. Further, it is preferable that the ratio of the mesopore volume to the total pore volume (the mesopore volume ratio) is from 50 to 80%.

The porous carbon material of the present invention has a specific surface area of preferably from 200 to 3,000 m²/g, more preferably from 600 to 2,200 m²/g, and further preferably from 1,400 to 2,000 m²/g.

Further, the specific surface area can be determined by a BET method (a Brunauer-Emmett-Teller method).

Further, the micropore volume of the porous carbon material of the present invention determined by the DR method (the Dubinin-Radushkevich method) is preferably from 0.40 to 0.70 mL/g, and the micropore volume determined by the HK method (the Horvath-Kawazoe method) is preferably from 0.42 to 0.70 mL/g. On the other hand, the mesopore volume is preferably from 0.50 to 2.00 mL/g.

### Electric Double-Layer Capacitor>>

Since the carbon porous material of the present invention is high in the ratio of mesopores of 2 to 50 nm in the pores thereof and has many of such pores, it is advantageous for the penetration of an electrolyte solution and the migration of ions and is favorable in the rate property, when it is formed into an electrode for an electric double-layer capacitor. Further, since the ratio of mesopores is high, the carbon porous material can be formed into an electrode for a capacitor high in the specific capacity even under a quite low temperature.

The electrode for an electric double-layer capacitor of the present invention is obtained by binding the above-mentioned carbon porous material with a binder resin and forming into a shape of a sheet or the like. As the binder resin, use may be made of usually-used ones, such as polytetrafluoroethylene (PTFE). At this time, a suitable amount of carbon black or the like can be added. The shape of the electrode is not particularly limited.

The electric double-layer capacitor of the present invention is similar to a conventional electric double-layer capacitor, except that the above-mentioned electrode for an electric double-layer capacitor is used. Specifically, the electric double-layer capacitor may be one, in which the above-mentioned electrodes for an electric double-layer capacitor are provided so that they oppose to each other via a separator, and these electrodes are impregnated into a respective electrolyte solution, to act as an anode and a cathode, respectively.

The electric double-layer capacitor using the porous carbon material of the present invention in the electrode can be operated under a quite low temperature lower than −30° C. According to the present invention, with respect to the electric power (Wh/Kg) of the electric double-layer capacitor, it is preferable that the electric power holding ratio at −40° C. or lower is 90% or more to the electric power (Wh/Kg) at 20° C., and it is preferable that the electric power holding ratio at −60° C. or lower is 70% or more to the electric power at 20° C.

### EXAMPLES

The present invention will be described in more detail based on examples given below, but the invention is not meant to be limited by these.

### (Examples 1 and 2, Comparative Example 1)

### <Pore Properties of Carbon Porous Material>

(1) Magnesium citrate (trimagnesium dicitrate nonahydrate, Mg₃(C₆H₅O₇)₂.9H₂O) was placed in a ceramics boat to fill the same, followed by setting in a horizontal tubular electric furnace, and heating to 900° C. at a temperature rising speed of 10° C./min by a programmable temperature controller. After retaining at 900° C. for 1 hour, the reaction product was cooled naturally, to give a calcined sample. In the reaction time period, high purity nitrogen (99.9999% or more) was passed through the reaction atmosphere.

In Example 1, the following treatment (2) was carried out, and in Example 2, the following treatments (2) and (3) were carried out.
(2) The calcined sample obtained by the above-mentioned procedures was treated with an excess amount of dilute sulfuric acid for 3 hours or more, followed by washing with pure water, filtering and drying, to remove the MgO particles in the calcined sample.
(3) The sample to which the above-described treatment (2) was applied was heated at 1,000° C. under a nitrogen stream, followed by subjecting to a highly purification treatment to remove the surface oxygen-containing functional group.

In Comparative example 1, an active carbon developed for use in a commercially-available organic EDLC was used.

From an argon adsorption isotherm at 82K obtained by measuring pore properties of these respective samples by means of an automatic nitrogen absorption measuring device, the values of the items shown in Table 1 were determined.

The thus-obtained results are collectively shown in Table 1.

Further, these values and the calculation methods are as follows:

A specific surface area was determined according to the BET method (the Brunauer-Emmett-Teller method), the total pore volume was an absorption capacity obtained from the adsorption isotherm at a relative pressure of 0.95 [-], the micropore capacity was determined according to the DR method (the Dubinin-Radushkevich method), the micropore volume was determined by the HK method (the Horvath-Kawazoe method), and the mesopore volume and the mesopore volume ratio were calculated by the following formulas, respectively.

Mesopore volume=(Total pore volume)−(Micropore volume)

Mesopore volume ratio (%)=(Mesopore volume)/(Total pore volume)×100

TABLE 1

| | | | Micropore | | | Micropore |
|---|---|---|---|---|---|---|
| | Specific | Total | volume | | Mesopore | volume |
| | surface | pore | (DR | Mesopore | volume | (HK |
| | area | volume | method) | volume | ratio | method) |
| | m²/g | mL/g | mL/g | mL/g | % | mL/g |
| Ex 1 | 1,530 | 2.15 | 0.56 | 1.59 | 74 | 0.55 |
| Ex 2 | 1,581 | 2.15 | 0.59 | 1.56 | 73 | 0.57 |
| Comp | 1,360 | 0.76 | 0.63 | 0.13 | 17 | 0.63 |
| ex 1 | | | | | | |

Notes:
“Ex” means Example according to this invention, and “Comp ex” means Comparative example (the same will be applied herein).

As can be seen in Table 1, as shown in the above-mentioned procedures by only the cancination of the precursors and the acid treatment, in Examples 1 and 2, porous carbon materials were obtained each of which had a large specific surface area that was not less than the specific surface area (generally from about 800 to 1,000 m²/g) of a general-purpose active carbon. The porous carbon materials each had a remarkably-developed porous structure, in which the total pore volume reached 2.15 mL/g. As is apparent from the comparison with Comparative example 1, the micropore volumes of Examples 1 and 2 were in the same level as that of Comparative example 1. On the contrary, in Examples 1 and 2, the mesopore volume was about 1.6 mL/g, and it is apparent that this mesopore volume is remarkably larger as compared with 0.13 mL/g of Comparative example 1. As a result, while the mesopore volume ratio (%) was as small as 17% in Comparative example 1, the mesopore volume ratio (%) was a very large value, namely, 74%, 73%, in Examples 1 and 2, respectively.

In other words, the porous carbon material of the present invention has a quite large number of mesopores in the pore distribution thereof.

### <Electrochemical Evaluation>

10 mg of any of the samples of the carbon porous materials shown in Table 1 (Examples 1 and 2, and Comparative Example 1) was weighed, acetone was added dropwise thereto together with 10 mass % of PTFE (polytetrafluoroethylene) and 10 mass % of carbon black, and the resultant respective mixture was kneaded, followed by rolling by rolling rolls, to give the respective sheet with thickness about 0.1 mm. From the resultant respective sheet, a disk-shape sheet with diameter 10 mm was punched out. Using the thus-shaped disk-shape sheet as a working electrode, a tripolar laminate-type test cell was made, using a silver wire as a reference electrode, and an aluminum electric power collector. As an electrolyte, 1 mol/L tetraethyl ammonium tetrafluoroborate/propylene carbonate (TEABF₄/PC) was used. In an electrochemical measurement, by repeating a constant current charge-and-discharge cycle at a current density of 0.2 mA/cm² in a range of 2.5 to 0V, a specific capacity was obtained from a discharge curve at the 6th cycle. The measurement was carried out after retaining for 10 hours at a temperature of 20° C., 0° C., −20° C., −40° C., −60° C., −70° C., and −80° C., respectively.

The measurement of the constant current charge-and-discharge cycle curve, was carried out, using VMP2-Z (trade name, manufactured by Biologic). An electrochemical evaluation was carried out, by retaining at the predetermined temperature, by using a portable quite-low-temperature thermostat MC-811(trade name, manufactured by ESPEC Corp.).

The results are shown in Table 2.

TABLE 2

| | Temp. (° C.) | 20° C. | 0° C. | −20° C. | −40° C. | −60° C. | −70° C. | −80° C. |
|---|---|---|---|---|---|---|---|---|
| Ex 1 | Capacity | 28.6 | 27.8 | 28.1 | 26.8 | 24.6 | 18.1 | 0.02 |
| | (F/g) | | | | | | | |
| | Capacity holding | 100 | 97.3 | 98.1 | 93.7 | 86.1 | 63.3 | 0.07 |
| | ratio (%) | | | | | | | |
| | Electric power | 24.2 | 23.7 | 23.9 | 22.7 | 17.9 | 5.9 | 0.01 |
| | (Wh/Kg) | | | | | | | |
| | Electric power | 100 | 97.7 | 98.6 | 93.7 | 73.8 | 24.5 | 0.05 |
| | holding ratio (%) | | | | | | | |
| Ex 2 | Capacity | 26.6 | 25.4 | 25.9 | 24.4 | 22.0 | 15.7 | 0.02 |
| | (F/g) | | | | | | | |
| | Capacity holding | 100 | 95.4 | 97.6 | 91.9 | 82.9 | 59.0 | 0.07 |
| | ratio (%) | | | | | | | |
| | Electric power | 21.9 | 20.9 | 21.7 | 20.2 | 15.6 | 5.0 | 0.01 |
| | (Wh/Kg) | | | | | | | |
| | Electric power | 100 | 95.8 | 99.4 | 92.3 | 71.2 | 22.8 | 0.05 |
| | holding ratio (%) | | | | | | | |
| Comp | Capacity | 24.1 | 23.7 | 23.0 | 18.2 | 7.7 | 3.1 | 0.03 |
| ex 1 | (F/g) | | | | | | | |
| | Capacity holding | 100 | 98.3 | 95.6 | 75.6 | 32.1 | 12.8 | 0.14 |
| | ratio (%) | | | | | | | |
| | Electric power | 21.6 | 21.2 | 20.3 | 14.7 | 5.1 | 1.5 | 0.01 |
| | (Wh/Kg) | | | | | | | |
| | Electric power | 100 | 98.1 | 94.1 | 68.3 | 23.5 | 6.9 | 0.07 |
| | holding ratio (%) | | | | | | | |

The electrodes in Examples 1 and 2 each show a higher capacity than Comparative example 1 at all of the temperatures under the conditions tested, and they have excellent properties when utilized in an electric double-layer capacitor.

A capacity holding ratio (%) is a ratio % of a capacity at each measurement temperature to the capacity at 20° C. At −40° C., Example 1 showed a capacity holding ratio of 93.7%, and Example 2 showed a capacity holding ratio of 91.9%. On the contrary, Comparative example 1 showed a capacity holding ratio of 75.6%. At −60° C. or lower, the difference becomes more remarkable, Comparative example 1 showed a capacity holding ratio of 32.1%, whereas Example 1 showed a capacity holding ratio of 86.1%, and Example 2 showed a capacity holding ratio of 82.9%. As a result, Examples 1 and 2 each have excellent properties. Further, the capacity at −60° C. is 24.6 F/g in Example 1, 22.0 F/g in Example 2, and each of those corresponds to the value of the capacity 24.1 F/g at 20° C. (room temperature) of Comparative example 1. This indicates that Examples 1 and 2 can be operated even at −60° C.

From the above, it can be understood that, when the porous carbon material of the present invention is used in an electrode, this material can be used in cold climates, such as ones in the North America and Europe, in the aerospace, deep ocean, polar regions, and the like.

Separately, the above electrochemical evaluation was carried out, except for changing the electrolyte to 1 mol/L triethyl methyl ammonium tetrafluoroborate/propylene carbonate (TEMABF₄/PC). Then, similar to the above, it is confirmed that Examples 1 and 2 using the porous carbon material of the present invention exhibited excellent properties, and that the electric double-layer capacitors of Examples 1 and 2 was able to operate even at −60° C.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2012-136422 filed in Japan on Jun. 15, 2012, which is entirely herein incorporated by reference.

1. A porous carbon material, wherein a total pore volume is 1 mL/g or more, and wherein a ratio of a mesopore volume to the total pore volume is 50% or more.

2. The porous carbon material according to claim 1, which is obtainable by: heating magnesium citrate to 500° C. or more under an inert atmosphere, followed by cooling and then washing with an acid.

3. An electrode material for an electric double-layer capacitor, which is obtained by: binding the porous carbon material according to claim 1 with a binder resin.

4. An electric double-layer capacitor, comprising the electrode material for an electric double-layer capacitor according to claim 3 in an electrode.

5. The electric double-layer capacitor according to claim 4, wherein an electric power holding ratio at −40° C. or lower to an electric power at 20° C. is 90% or higher.

6. The electric double-layer capacitor according to claim 4, wherein an electric power holding ratio at −60° C. or lower to an electric power at 20° C. is 70% or higher.

7. The electric double-layer capacitor according to claim 5, wherein an electric power holding ratio at −60° C. or lower to an electric power at 20° C. is 70% or higher.

8. An electrode material for an electric double-layer capacitor, which is obtained by: binding the porous carbon material according to claim 2 with a binder resin.

9. An electric double-layer capacitor, comprising the electrode material for an electric double-layer capacitor according to claim 8 in an electrode.

10. The electric double-layer capacitor according to claim 9, wherein an electric power holding ratio at −40° C. or lower to an electric power at 20° C. is 90% or higher.

11. The electric double-layer capacitor according to claim 9, wherein an electric power holding ratio at −60° C. or lower to an electric power at 20° C. is 70% or higher.

12. The electric double-layer capacitor according to claim 10, wherein an electric power holding ratio at −60° C. or lower to an electric power at 20° C. is 70% or higher.

13. A method of producing a porous carbon material, comprising the steps of:
heating magnesium citrate under an inert atmosphere to 500° C. or higher;
cooling; and
washing with an acid,
wherein the porous carbon material has a total pore volume of 1 mL/g or more, and a ratio of a mesopore volume to the total pore volume of 50% or higher.

14. The method of producing a porous carbon material according to claim 13, wherein, in the heating step, a temperature rising speed to a retention temperature at 500° C. or higher is 1 to 100° C./min.

15. The method of producing a porous carbon material according to claim 13, wherein, in the heating step, a retention time period at 500° C. or higher after being raised to 500° C. is 1 to 5,000 minutes.

16. The method of producing a porous carbon material according to claim 14, wherein, in the heating step, a retention time period at 500° C. or higher after being raised to 500° C. is 1 to 5,000 minutes.

17. The method of producing a porous carbon material according to claim 13, which comprises: removing a surface oxygen-containing functional group, after the steps of cooling and washing with an acid.

18. The method of producing a porous carbon material according to claim 16, which comprises: removing a surface oxygen-containing functional group, after the steps of cooling and washing with an acid.
